(19) United States
(12) Patent Application Publication
(10) Pub. No.: US 2026/0312742 A1
(43) Pub. Date: Oct. 8, 2026

(54) SELF-ADAPTIVE WAVEFORM DESIGN METHOD FOR UNMANNED AERIAL VEHICLE (UAV)-ENABLED INTEGRATED SENSING AND COMMUNICATION (ISAC)

(71) Applicant: UNIVERSITY OF ELECTRONIC SCIENCE AND TECHNOLOGY OF CHINA, Chengdu (CN)

(72) Inventors: Yiqian HUANG, Chengdu (CN); Ping YANG, Chengdu (CN); Gang WU, Chengdu (CN)

(73) Assignee: UNIVERSITY OF ELECTRONIC SCIENCE AND TECHNOLOGY OF CHINA, Chengdu (CN)

(21) Appl. No.: 19/216,801

(22) Filed: May 23, 2025

(30) Foreign Application Priority Data
Apr. 2, 2025 (CN) 202510412480.0

(51) Int. Cl. H04L 5/00; H04L 1/00

(52) U.S. Cl. CPC H04L 5/0007; H04L 1/0009; H04L 5/0098

(57) ABSTRACT

A self-adaptive waveform design method for unmanned aerial vehicle (UAV)-enabled integrated sensing and communication (ISAC) is provided. In a waveform designed by the self-adaptive waveform design method, subcarriers are classified into two types: modulation subcarriers and optimization subcarriers, to implement collaborative optimization of communication and sensing functions. In each transmission, symbols on the modulation subcarriers are generated through a maximum distance separable (MDS) code-based in-phase and quadrature modulation (MDS-IQM) method, whereas symbols on the optimization subcarriers are self-adaptively generated based on the symbols on the modulation subcarriers, to optimize communication performance, sensing performance, and a peak-to-average power ratio (PAPR) of the waveform. The self-adaptive waveform design method provides a feasible technical solution for a UAV-enabled ISAC application scenario. Featuring high communication efficiency and sensing performance and outstanding performance in reducing a PAPR, the solution can effectively improve overall performance of a UAV communication system.

### CROSS REFERENCE TO THE RELATED APPLICATIONS

This application is based upon and claims priority to Chinese Patent Application No. 202510412480.0, filed on Apr. 2, 2025, the entire contents of which are incorporated herein by reference.

### TECHNICAL FIELD

The present disclosure belongs to the technical field of wireless communication, and specifically, relates to a self-adaptive coding and modulation waveform design and a system for unmanned aerial vehicle (UAV)-enabled integrated sensing and communication (ISAC).

### BACKGROUND

With the continuous progress of technologies and increasing diversity of application requirements, the UAV industry is developing rapidly and has become an important driving force in many fields, such as modern logistics, agriculture, and environmental monitoring. In this context, an ISAC technology provides important support for sustainable development of the UAV industry by optimizing resource utilization and improving safety and service efficiency. Therefore, it is particularly important to design a waveform suitable for UAV-enabled ISAC.

In existing waveforms, orthogonal frequency division multiplexing (OFDM) and its variants have become a research hotspot in the ISAC field due to their strong anti-interference capability and efficient hardware implementation. In recent years, a lot of research literature has conducted in-depth discussions on an OFDM-based ISAC waveform, and further achieved an optimal balance between communication performance and sensing performance of the waveform through technologies such as power allocation and probabilistic constellation shaping. In 2022, F. Yarkin and J. Coon proposed a maximum distance separable (MDS) code-based coding and modulation OFDM (MDS-OFDM) waveform. Research shows that this waveform outperforms a conventional OFDM waveform in terms of bit error rate (BER) performance while achieving robust sensing performance. Therefore, the MDS-OFDM waveform has great potential in application to UAV-enabled ISAC and is worth further research and development.

Although the MDS-OFDM waveform has shown outstanding potential in the UAV-enabled ISAC field, it inherits a high peak-to-average power ratio (PAPR) inherent in the OFDM waveform. The high PAPR causes distortion of a signal when it passes through a high power amplifier (TPA), which adversely affects communication and sensing performance. This problem is particularly acute in a UAV-enabled ISAC scenario because communication and sensing coverage of a UAV network is wider than that of a conventional terrestrial network. Therefore, reducing the PAPR of the MDS-OFDM waveform is a key to ensuring its effectiveness in the application to UAV-enabled ISAC.

Existing PAPR reduction techniques, such as clipping, tone reservation, and selective mapping, are effective to a certain extent, but have some limitations. The clipping technique changes amplitudes of some subcarriers, which may affect communication reliability of the waveform. The tone reservation and selective mapping techniques reduce spectral efficiency (SE) of the waveform. Considering check information of an MDS code has occupied part of spectrum resources, a PAPR reduction technique that further reduces SE may not be suitable for the MDS-OFDM waveform. Therefore, designing and optimizing a low-PAPR MDS-OFDM waveform for ISAC is still a subject that urgently needs to be studied in more depth.

### SUMMARY

An objective of the present disclosure is to provide a self-adaptive MDS-OFDM waveform for ISAC in view of a high PAPR of an MDS-OFDM waveform, to make the waveform more suitable for a UAV-enabled ISAC scenario.

The technical solutions of the present disclosure are as follows:

A self-adaptive waveform design method for UAV-enabled ISAC is provided. In a UAV-enabled ISAC system, a UAV communicates with a user and senses an unauthorized target through a same waveform. A sensing platform is the UAV The method includes the following steps:
S1: classifying subcarriers into two types: modulation subcarriers and optimization subcarriers, where positions of the optimization subcarriers are used to carry additional information, symbols on the optimization subcarriers are self-adaptively generated based on symbols on the modulation subcarriers, and the symbols on the modulation subcarriers are generated through an MDS code-based in-phase and quadrature modulation (MDS-IQM) method;
S2: classifying input information bits into two types: modulation bits and optimization bits, where the optimization bits are used to determine the positions of the optimization subcarriers, and the modulation bits are used to determine the symbols on the modulation subcarriers; and
S3: based on settings in S1 and S2, generating modulation symbols by using the input bits; and performing OFDM modulation to obtain a transmitted waveform.

Further, S1 specifically includes:
defining that there are N subcarriers in the system; dividing the subcarriers into G=N/n′ sub-blocks, where each sub-block has n′ subcarriers; dividing the n′ subcarriers into F groups in sequence, where each group has n=n′/F subcarriers; and classifying the F groups into 1 group of optimization subcarriers and F−1 groups of modulation subcarriers.

Further, S2 specifically includes:
dividing L input bits into G groups, where each group has l=L/G bits, and each group of bits determines transmission symbols of an OFDM sub-block; and defining the first l^{O}=log₂ F bits in the l bits as optimization bits, which are used as index bits to determine positions of the group of optimization subcarriers, and the other (F−1)l^{m} bits as modulation bits, which are used to determine symbols on the F−1 groups of modulation subcarriers.

Further, S3 specifically includes:
determining the positions of the group of optimization subcarriers in the g^{th} sub-block based on an index bit stream b_{g}=[b_{g} (1), b_{g} (2), . . . , b_{g} (l^{O})]\hat{ }T, where g∈{1, 2, . . . , G}

$${I}_{g} = {\sum }_{{l}^{′} = 1}^{{l}^{o}} {2}^{{l}^{′} - 1} {b}_{g} ( {l}^{′} ) + 1$$

where I_{g} represents the positions of the optimization subcarriers in the g^{th} sub-block; and
obtaining the symbols on the F−1 groups of modulation subcarriers based on the (F−1)l^{m} modulation bits.

Because symbol generation steps are the same for the groups of modulation subcarriers. One group of modulation subcarriers is used as an example to illustrate a symbol generation process. A quantity of bits carried by one group of modulation subcarriers is l^{m}. First, a KM-dimensional pulse amplitude modulation (PAM) constellation S¹={S¹(1), S¹(2), . . . , S¹(KM)} and an RM-dimensional PAM constellation S²={S²(1), S²(2), . . . , S²(KR)} are generated. Next, S¹ and S² are equally divided into K and R M-dimensional PAM constellations

$$\{ {S}_{1}^{i} , {S}_{2}^{i} , … , {S}_{K}^{i} \}$$

and

$$\{ {S}_{1}^{i} , {S}_{2}^{q} , … , {S}_{R}^{q} \}$$

based on index intervals K and R respectively.

$$\{ {S}_{1}^{i} , {S}_{2}^{i} , … , {S}_{K}^{i} \}$$

is used for in-phase modulation.

$$\{ {S}_{1}^{q} , {S}_{2}^{q} , … , {S}_{R}^{q} \}$$

is used for quadrature modulation.

$$\{ {S}_{1}^{i} , {S}_{2}^{i} , … , {S}_{K}^{i} \} and \{ {S}_{1}^{q} , {S}_{2}^{q} , … , {S}_{R}^{q} \}$$

are generated as follows:

$${S}_{k}^{i} = \{ {S}^{1} ( k ) , {S}^{1} ( k + K ) , … , {S}^{1} ( k + ( M - 1 ) K ) \} , k = 1 , 2 , … , K$$

$${S}_{r}^{q} = \{ {S}^{2} ( r ) , {S}^{2} ( r + R ) , … , {S}^{2} ( r + ( M - 1 ) R ) \} , r = 1 , 2 , … , R$$

l^{m} input bits carried by the group of modulation subcarriers are divided into two parts: The first lⁱ bits are used for in-phase modulation and the last l^{q} bits are used for quadrature modulation:

$${l}^{i} = {l}_{1}^{i} + {l}_{2}^{i} = ( n - 1 ) {log}_{2} K + n {log}_{2} M$$

$${l}^{q} = {l}_{1}^{q} + {l}_{2}^{q} = ( n - 1 ) {log}_{2} R + n {log}_{2} M$$

MDS coding is performed on the

$${l}_{1}^{i}$$

bits to obtain MDS codewords {cⁱ(1), cⁱ(2), . . . , cⁱ(n)} and on the

$${l}_{1}^{q}$$

bits to obtain MDS codewords {c^{q}(1), c^{q}(2), . . . , c^{q}(n)}. After MDS codes are generated, every log₂ M bits in the

$${l}_{2}^{i}$$

bits and the

$${l}_{2}^{q}$$

bits are further converted into a corresponding decimal number to obtain {dⁱ(1), dⁱ(2), . . . , dⁱ(n)} and {d^{q}(1), d^{q}(2), . . . , d^{q}(n)}, such that an in-phase component sⁱ={sⁱ(1), sⁱ(2), . . . , sⁱ(n)} and a quadrature component s^{q}={s^{q}(1), s^{q}(2), . . . , s^{q}(n)} of the modulation subcarriers are obtained, which are expressed as follows:

$$\{ \begin{matrix}{s}^{i} ( a ) = \text{?} ( {d}^{i} ( a ) ) \\ {s}^{q} ( a ) = \text{?} ( {d}^{q} ( a ) )\end{matrix} , a = 1 , 2 , … , n$$

sⁱ=[sⁱ(1), sⁱ(2), . . . , sⁱ(n)]^{T} and s^{q}=[s^{q}(1), s^{q}(2), . . . , s^{q}(n)]^{T} respectively represent the in-phase component and the quadrature component of the group of modulation subcarriers. The symbol s^{m} on the group of modulation subcarriers is as follows:

$${s}^{m} = {s}^{i} + j {s}^{q}$$

The foregoing modulation method is repeated for F−1 times to obtain the symbols on the F−1 groups of modulation subcarriers in the g^{th} sub-block. The foregoing steps are repeated for G times to obtain symbols on all modulation subcarriers in an OFDM symbol. The symbols on the optimization subcarriers are generated based on the symbols on the G(F−1) groups of modulation subcarriers.

A method for self-adaptively generating the symbols on the optimization subcarriers based on the symbols on the modulation subcarriers is as follows:
determining a power of the group of optimization subcarriers through a discrete search method with an objective of minimizing a bit error rate (BER), which specifically includes: generating a plurality of powers at equal intervals, and performing simulation to obtain BERs of the system at the powers, where the power corresponding to the smallest BER is a power sum of the group of optimization subcarriers, which is denoted as α̌^{O}.
optimizing a power of each optimization subcarrier with an objective of minimizing a peak sidelobe level (PSL) of the waveform, where the power sum of each group of optimization subcarriers is α̌^{O}; and the PSL of the waveform is Fourier transform of a power spectral density of a transmitted signal vector in frequency domain, and a PSL minimization problem may be transformed into a convex optimization problem, which may be efficiently solved through a convex optimization toolbox, such as CVX; and
determining a phase of the optimization subcarrier with an objective of minimizing a PAPR of the waveform, which is specifically as follows: when a power of the waveform meets a normalization condition, a PAPR of an optimized waveform is equivalent to an infinite norm of the optimized waveform, and the optimization problem may also be transformed into a convex optimization problem, which is solved through a convex optimization toolbox.

The present disclosure has the following beneficial effects: The present disclosure can significantly reduce a PAPR of an MDS-OFDM waveform while maintaining reliable communication and sensing, to significantly reduce distortion of a signal when it passes through an HPA. Therefore, the waveform is more suitable for a future UAV-enabled ISAC scenario.

### BRIEF DESCRIPTION OF THE DRAWINGS

FIG. 1 is a schematic diagram of waveform generation and system design according to the present disclosure;

FIG. 2 is a schematic diagram of a BER comparison of the present disclosure with a conventional OFDM waveform and an MDS-OFDM waveform with a non-ideal HPA used;

FIG. 3 is a schematic diagram of a PSL comparison of the present disclosure with a conventional OFDM waveform and an MDS-OFDM waveform; and

FIG. 4 is a schematic diagram of a PAPR comparison of the present disclosure with a conventional OFDM waveform and an MDS-OFDM waveform.

### DETAILED DESCRIPTION OF THE EMBODIMENTS

The following demonstrates effectiveness and practicality of the present disclosure with reference to the accompanying drawings and simulation examples:

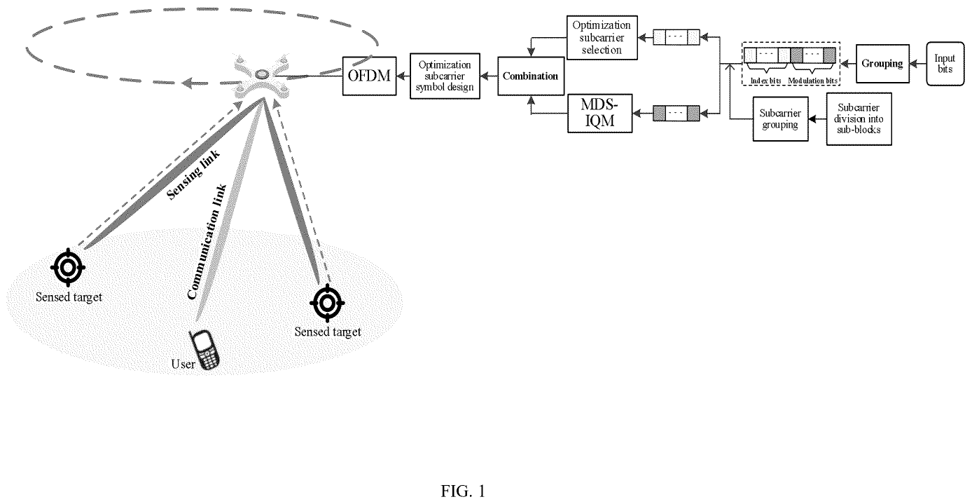

The present disclosure provides a self-adaptive coding and modulation waveform design method for UAV-enabled ISAC. As shown in FIG. 1, in a UAV-enabled ISAC system, a UAV communicates with a user and senses an unauthorized target through a same waveform. A sensing platform is the UAV. In this waveform, subcarriers are classified into two types: modulation subcarriers and optimization subcarriers. In each transmission, symbols on the modulation subcarriers are generated through an MDS-IQM method, whereas symbols on the optimization subcarriers are self-adaptively generated based on the symbols on the modulation subcarriers, to jointly optimize communication performance, sensing performance, and a PAPR of the waveform. To further improve SE of the waveform, positions of the optimization subcarriers are used to carry additional information. Therefore, input bits are divided into two parts: index bits used to determine the positions of the optimization subcarriers, and modulation bits used to determine the symbols on the modulation subcarriers. A communication receiver restores information bits from a received waveform. The UAV senses the unauthorized target based on an echo of a transmitted waveform.

The present disclosure includes the following steps:
S1: N subcarriers of an OFDM symbol are divided into G sub-blocks in sequence. Each sub-block has n′=N/G subcarriers. The n′ subcarriers in each sub-block are divided into F groups in sequence. Each group has n=n′/F subcarriers. The F groups of subcarriers in each sub-block are further classified into two types: one group of optimization subcarriers and F−1 groups of modulation subcarriers.
S2: L input bits are divided into G groups. Each group has l=L/G bits. The l information bits in each group are further classified into two types: The first l^{O}=log₂ F index bits are used to determine the positions of the group of optimization subcarriers. The other (F−1)l^{m} bits are used to determine the symbols on the F−1 groups of modulation subcarriers. l^{m}=(n−1)log₂ KR-+2n log₂ M is a quantity of bits carried by one group of modulation subcarriers. K and R are respectively modulation orders of an in-phase component and a quadrature component. M is a quantity of dimensions of a PAM constellation. Based on the foregoing relationship, a quantity of information bits carried by one sub-block may be obtained through Formula 1 below:

$$l = {l}^{o} + ( F - 1 ) {l}^{m} = {log}_{2} F + ( F - 1 ) ( ( n - 1 ) {log}_{2} KR + 2 n {log}_{2} M ) \qquad ( Formula 1 )$$

S3: The positions of the optimization subcarriers are determined based on the index bits of each sub-block. For example, in the g^{th} sub-block (g∈{1, 2, . . . , G}), it is assumed that the input bits are b_{g}=[b_{g} (1), b_{g} (2), . . . , b_{g} (l^{O})]^{T}. The positions (denoted as I_{g}) of the group of optimization subcarriers in the g^{th} sub-block are calculated through Formula 2 below:

$${I}_{g} = {\sum }_{{l}^{′} = 1}^{{l}^{o}} {2}^{{l}^{′} - 1} {b}_{g} ( {l}^{′} ) + 1 \qquad ( Formula 2 )$$

MDS-IQM is performed on the G(F−1) groups of modulation subcarriers. Taking one group of modulation subcarriers as an example, an MDS-IQM process is as follows:

First, a KM-dimensional PAM constellation and an RM-dimensional PAM constellation are generated. Next, symbols of the two constellations are equally divided into K and R M-dimensional PAM constellations

$$\{ {S}_{1}^{i} , {S}_{2}^{i} , … , {S}_{K}^{i} \} and \{ {S}_{1}^{q} , {S}_{2}^{q} , … , {S}_{R}^{q} \}$$

based on index intervals K and R respectively.

$$\{ {S}_{1}^{i} , {S}_{2}^{i} , … , {S}_{K}^{i} \}$$

is used for in-phase modulation.

$$\{ {S}_{1}^{q} , {S}_{2}^{q} , … , {S}_{R}^{q} \}$$

is used for quadrature modulation. Then, the l^{m} bits are divided into two parts: The first lⁱ bits are used for in-phase modulation, and the last l^{q} bits are used for quadrature modulation. lⁱ and l^{q} are calculated through the following formulas 3 and 4:

$${l}^{i} = {l}_{1}^{i} + {l}_{2}^{i} = ( n - 1 ) {log}_{2} K + n {log}_{2} M \qquad ( Formula 4 )$$

$${l}^{q} = {l}_{1}^{q} + {l}_{2}^{q} = ( n - 1 ) {log}_{2} R + n {log}_{2} M \qquad ( Formula 5 )$$

Then, MDS coding is performed on the

$${l}_{1}^{i}$$

bits and the

$${l}_{1}^{q}$$

bits. For example, a specific process of performing MDS coding on the

$${l}_{1}^{i}$$

bits is as follows: First, every log₂ K bits in the

$${l}_{1}^{i}$$

bits are converted into a corresponding decimal number. A calculation formula is the same as Formula 2. Obtained decimal numbers n−1 are denoted as {cⁱ(1), cⁱ(2), . . . , cⁱ(n−1)}. The n−1 numbers are first n−1 codewords of an MDS code used for in-phase modulation. The n^{th} codeword is a check codeword. A calculation formula is Formula 5 below:

$${c}^{i} ( n ) = K - ( {c}^{i} ( 1 ) + {c}^{i} ( 2 ) + ⋯ + {c}^{i} ( n - 1 ) ) mod K \qquad ( Formula 5 )$$

mod represents a modulo operation. A process of generating an MDS code for the

$${l}_{1}^{q}$$

bits is similar. It is only necessary to replace K with R. A n-dimensional MDS code corresponding to the

$${l}_{1}^{q}$$

bits is denoted as {c^{q}(1), c^{q}(2), . . . , c^{q}(n)}. Then, every log₂ M bits in the

$${l}_{2}^{i}$$

bits and the

$${l}_{2}^{q}$$

bits is converted into a corresponding decimal number. A calculation formula is the same as Formula 2. Obtained n-dimensional results are denoted as {dⁱ(1), dⁱ(2), . . . , dⁱ(n)} and {d^{q}(1), d^{q}(2), . . . , d^{q}(n)}. Based on the PAM constellations

$$\{ {S}_{1}^{i} , {S}_{2}^{i} , … , {S}_{K}^{i} \} and \{ {S}_{1}^{q} , {S}_{2}^{q} , … , {S}_{K}^{q} \} ,$$

MDS codewords {cⁱ(1), cⁱ(2), . . . , cⁱ(n)} and {c^{q}(1), c^{q}(2), . . . , c^{q}(n)}, and {dⁱ(1), dⁱ(2), . . . , dⁱ(n)} and {d^{q}(1), d^{q}(2), . . . , d^{q}(n)} of the in-phase component and the quadrature component, an in-phase component and a quadrature component of one group of modulation subcarriers are generated through Formula 6 below:

$$\{ \begin{matrix}{s}^{i} ( a ) = \text{?} ( {d}^{i} ( a ) ) \\ {s}^{q} ( a ) = \text{?} ( {d}^{q} ( a ) )\end{matrix} , a = 1 , 2 , … , n \qquad ( Formula 6 )$$

sⁱ=[sⁱ(1), sⁱ(2), . . . , sⁱ(n)]^{T} and s^{q}=[s^{q}(1), s^{q}(2), . . . , s^{q}(n)]^{T} respectively represent the in-phase component and the quadrature component of the group of modulation subcarriers. Based on Formula 6, the symbols s^{m} on the group of modulation subcarriers may finally be generated through Formula 7 below:

$${s}^{m} = {s}^{i} + j {s}^{q} \qquad ( Formula 7 )$$

Symbols on the group of optimization subcarriers are self-adaptively designed based on the symbols on the group of modulation subcarriers, to jointly optimize a BER, a PSL, and the PAPR of the waveform. The PSL is a metric for measuring the sensing performance of the waveform. Specifically, an optimal power sum of the group of optimization subcarriers is first determined through a discrete search method with an objective of minimizing the BER. Then, under a constraint of the optimal power sum, a power of each subcarrier in the group of optimization subcarriers is optimized through convex optimization with an objective of minimizing the PSL. Finally, a phase of the optimization subcarrier is determined with an objective of minimizing the PAPR.

OFDM modulation, up-conversion, and radio frequency amplification are performed on a finally generated series of N-dimensional symbols, and finally the waveform is transmitted.

The communication receiver first performs down-conversion and OFDM demodulation on the received waveform, and then restores the information bits through a signal detection method. The signal detection method may be maximum likelihood detection, zero-forcing detection, minimum mean square error detection, or the like.

The UAV first performs down-conversion and OFDM demodulation on the received echo, and then may calculate information about (such as a distance and velocity of) the sensed target based on the received echo. A sensing algorithm may be a classical matched filtering algorithm, an efficient two-dimensional Fourier transform algorithm, and the like.

Simulation parameters are set as follows: One OFDM symbol contains 256 subcarriers. A communication channel is close to a propagation channel with large-scale fading in free space in a UAV scenario. A non-ideal HPA is used. Conventional OFDM uses 8QAM for modulation. A modulation order of MDS-OFDM is n=2, K=2, R=2, M=2. In a proposed A-MDS-OFDM-IM waveform, G=32 and a modulation order of MDS-IQM is the same as that of MDS-OFDM.

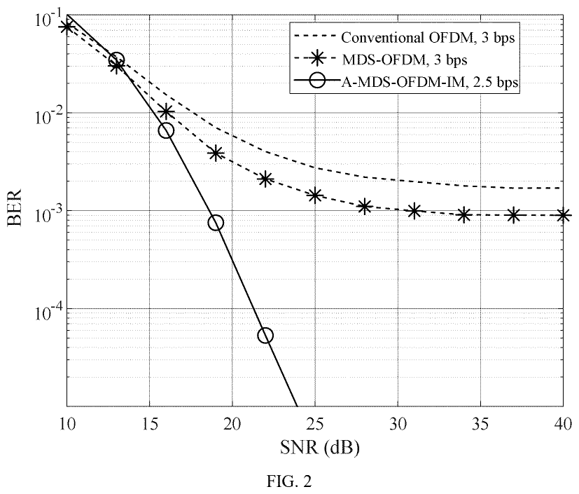

It can be learned from FIG. 2 that in a UAV communication scenario with a non-ideal HPA used, BER performance of the waveform in the present disclosure is significantly better than that of a contrast waveform. This advantage is especially obvious at a high signal-to-noise ratio.

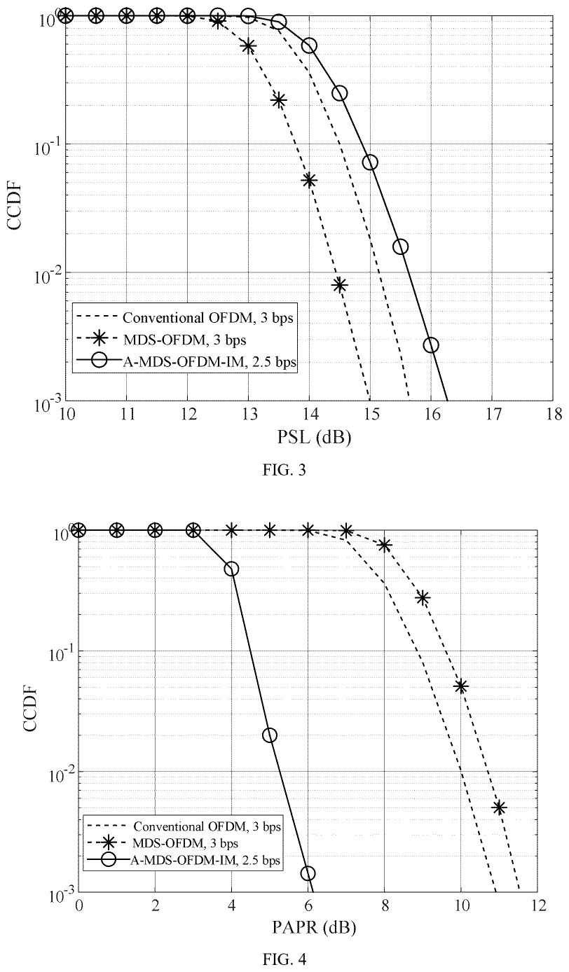

It can be learned from FIG. 3 that PSL performance of the waveform in the present disclosure is close to that of the contrast waveform. To be specific, the present disclosure significantly improves communication reliability of the system while ensuring a small loss of the sensing performance. In other words, the present disclosure implements a compromise between the communication performance and the sensing performance of the waveform, and the waveform is a feasible ISAC waveform.

It can be learned from FIG. 4 that the PAPR of the waveform in the present disclosure is significantly lower than that of the contrast waveform. Therefore, the waveform proposed in the present disclosure can achieve smaller signal distortion. This is obviously helpful to ensure communication and sensing reliability of the system. This solution can exert its advantages in a UAV network with wide coverage, thus becoming a feasible and effective solution.

1. A self-adaptive waveform design method for unmanned aerial vehicle (UAV)-enabled integrated sensing and communication (ISAC), wherein in a UAV-enabled ISAC system, a UAV communicates with a user and senses an unauthorized target through a same waveform, and a sensing platform is the UAV;
wherein the method comprises the following steps:
S1: classifying subcarriers into two types: modulation subcarriers and optimization subcarriers, wherein positions of the optimization subcarriers are used to carry additional information, symbols on the optimization subcarriers are self-adaptively generated based on symbols on the modulation subcarriers, and the symbols on the modulation subcarriers are generated through a maximum distance separable (MDS) code-based in-phase and quadrature modulation (MDS-IQM) method;
S2: classifying input information bits into two types: modulation bits and optimization bits, wherein the optimization bits are used to determine the positions of the optimization subcarriers, and the modulation bits are used to determine the symbols on the modulation subcarriers; and
S3: based on settings in S1 and S2, generating modulation symbols by using the input information bits; and performing orthogonal frequency division multiplexing (OFDM) modulation to obtain a transmitted waveform.

2. The self-adaptive waveform design method for UAV-enabled ISAC according to claim 1, wherein S1 comprises:
defining that there are N subcarriers in the UAV-enabled ISAC system; dividing the N subcarriers into G=N/n′ sub-blocks, wherein each sub-block has n′ subcarriers; dividing the n′ subcarriers into F groups in sequence, wherein each group has n=n′/F subcarriers; and classifying the F groups into 1 group of optimization subcarriers and F−1 groups of modulation subcarriers.

3. The self-adaptive waveform design method for UAV-enabled ISAC according to claim 2, wherein S2 comprises:
dividing L input bits into G groups, wherein each group has l=L/G bits; and defining the first l⁰=log₂ F bits in the l bits as optimization bits, wherein the optimization bits are used as index bits to determine positions of the group of optimization subcarriers, and the other (F−1)l^{m} bits as modulation bits, wherein the modulation bits are used to determine symbols on the F−1 groups of modulation subcarriers.

4. The self-adaptive waveform design method for UAV-enabled ISAC according to claim 3, wherein S3 comprises:
determining the positions of the group of optimization subcarriers in a g^{th} sub-block based on an index bit stream b_{g}=[b_{g}(1), b_{g}(2), . . . , b_{g}(l⁰)]\hat{ }T, wherein g∈{1, 2, . . . , G}:
$${I}_{g} = {\sum }_{{l}^{′} = 1}^{{l}^{0}} {2}^{{l}^{′} - 1} {b}_{g} ( {l}^{′} ) + 1$$
wherein I_{g} represents the positions of the optimization subcarriers in the g^{th} sub-block;
obtaining the symbols on the F−1 groups of modulation subcarriers based on the (F−1)l^{m} modulation bits; wherein
a method for performing modulation on one group of modulation subcarriers is as follows: generating a KM-dimensional pulse amplitude modulation (PAM) constellation S¹={S¹(1), S¹(2), . . . , S¹(KM)} and an RM-dimensional PAM constellation S²={S²(1), S (2), . . . , S²(KR)}, and equally dividing S¹ and S² into K and R M-dimensional PAM constellations
$$\{ {S}_{1}^{i} , {S}_{2}^{i} , … , {S}_{K}^{i} \} and \{ {S}_{1}^{q} , {S}_{2}^{q} , … , {S}_{R}^{q} \}$$
based on index intervals K and R respectively, wherein
$$\{ {S}_{1}^{i} , {S}_{2}^{i} , … , {S}_{K}^{i} \}$$
is used for in-phase modulation, and
$$\{ {S}_{1}^{q} , {S}_{2}^{q} , … , {S}_{R}^{q} \}$$
is used for quadrature modulation; and
$$\{ {S}_{1}^{i} , {S}_{2}^{i} , … , {S}_{K}^{i} \} and \{ {S}_{1}^{q} , {S}_{2}^{q} , … , {S}_{R}^{q} \}$$
are generated as follows:
$${S}_{k}^{i} = \{ {S}^{1} ( k ) , {S}^{1} ( k + K ) , … , {S}^{1} ( k + ( M - 1 ) K ) \} , k = 1 , 2 , … , K$$
$${S}_{r}^{q} = \{ {S}^{2} ( r ) , {S}^{2} ( r + R ) , … , {S}^{2} ( r + ( M - 1 ) R ) \} , r = 1 , 2 , … , R$$
dividing l^{m} input bits carried by the group of modulation subcarriers into two parts, wherein the first lⁱ bits are used for in-phase modulation and the last l^{q} bits are used for quadrature modulation:
$${l}^{i} = {l}_{1}^{i} + {l}_{2}^{i} = ( n - 1 ) {log}_{2} K + n {log}_{2} M$$
$${l}^{q} = {l}_{1}^{q} + {l}_{2}^{q} = ( n - 1 ) {log}_{2} R + n {log}_{2} M$$
performing MDS coding on the
$${l}_{1}^{i}$$
bits to obtain MDS codewords {cⁱ(1), cⁱ(2), . . . , cⁱ(n)} and on the
$${l}_{1}^{q}$$
bits to obtain MDS codewords {c^{q}(1), c^{q}(2), . . . , c^{q}(n)}; and after MDS codes are generated, converting every log₂ M bits in the
$${l}_{2}^{i}$$
bits and the
$${l}_{2}^{q}$$
bits into a corresponding decimal number to obtain {dⁱ(1), dⁱ(2), . . . , dⁱ(n)} and {d^{q}(1), d^{q}(2), . . . , d^{q}(n)}, such that an in-phase component sⁱ={sⁱ(1), sⁱ(2), . . . , sⁱ(n)} and a quadrature component s^{q}={s^{q}(1), s^{q}(2), . . . , s^{q}(n)} of the modulation subcarriers are obtained, and are expressed as follows:
$$\{ \begin{matrix}{s}^{i} ( a ) = \text{?} ( {d}^{i} ( a ) ) \\ {s}^{q} ( a ) = \text{?} ( {d}^{q} ( a ) )\end{matrix} , a = 1 , 2 , … , n$$
wherein sⁱ [sⁱ(1), sⁱ(2), . . . , sⁱ(n)]^{T} and s^{q}=[s^{q}(1), s^{q}(2), . . . , s^{q}(n)]^{T} respectively represent the in-phase component and the quadrature component of the group of modulation subcarriers, and the symbol s^{m} on the group of modulation subcarriers is as follows:
$${s}^{m} = {s}^{i} + j {s}^{q}$$
repeating the method for performing modulation on one group of modulation subcarriers for F−1 times to obtain the symbols on the F−1 groups of modulation subcarriers in the g^{th} sub-block; repeating the process of performing modulation on the g^{th} sub-block for G times to obtain symbols on all modulation subcarriers in an OFDM symbol; and generating the symbols on the optimization subcarriers based on the symbols on the G(F−1) groups of modulation subcarriers; wherein
a method for self-adaptively generating the symbols on the optimization subcarriers based on the symbols on the modulation subcarriers is as follows:
determining a power of the group of optimization subcarriers through a discrete search method with an objective of minimizing a bit error rate (BER), comprising: generating a plurality of powers at equal intervals, and performing simulation to obtain BERs of the UAV-enabled ISAC system at the powers, wherein the power corresponding to a smallest BER is a power sum of the group of optimization subcarriers, and is denoted as α̌^{O};
optimizing a power of each optimization subcarrier with an objective of minimizing a peak sidelobe level (PSL) of the waveform, wherein the power sum of each group of optimization subcarriers is α̌^{O}; and the PSL of the waveform is Fourier transform of a power spectral density of a transmitted signal vector in frequency domain, and a PSL minimization problem is transformed into a convex optimization problem, and the convex optimization problem is solved through a convex optimization toolbox; and
determining a phase of the optimization subcarrier with an objective of minimizing a peak-to-average power ratio (PAPR) of the waveform, wherein when a power of the waveform meets a normalization condition, a PAPR of an optimized waveform is equivalent to an infinite norm of the optimized waveform, and the optimization problem is also transformed into the convex optimization problem, and is solved through the convex optimization toolbox.
